(19) United States
(12) Patent Application Publication
(10) Pub. No.: US 2022/0346150 A1
(43) Pub. Date: Oct. 27, 2022

(54) MESSAGE REPETITIONS DURING A RANDOM ACCESS CHANNEL PROCEDURE

(71) Applicant: QUALCOMM Incorporated, San Diego, CA (US)

(72) Inventors: Gokul SRIDHARAN, Sunnyvale, CA (US); Mahmoud TAHERZADEH BOROUJENI, San Diego, CA (US); Hung Dinh LY, San Diego, CA (US); Wanshi CHEN, San Diego, CA (US)

(21) Appl. No.: 17/658,539

(22) Filed: Apr. 8, 2022

Related U.S. Application Data
(60) Provisional application No. 63/178,961, filed on Apr. 23, 2021.

(51) Int. Cl. H04W 74/08; H04L 1/08; H04L 5/14

(52) U.S. Cl. CPC H04W 74/0833; H04L 1/08; H04L 5/14

(57) ABSTRACT

Various aspects of the present disclosure generally relate to wireless communication. In some aspects, a user equipment (UE) may determine one or more of a mode of operation or an uplink-downlink channel reciprocity. The UE may transmit, to a network entity, a message 3 (Msg3) with repetitions during a random access channel (RACH) procedure based at least in part on one or more of the mode of operation or the uplink-downlink channel reciprocity. Numerous other aspects are described.

### CROSS-REFERENCE TO RELATED APPLICATION

This Patent Application claims priority to U.S. Provisional Patent Application No. 63/178,961, filed on Apr. 23, 2021, entitled “MESSAGE REPETITIONS DURING A RANDOM ACCESS CHANNEL PROCEDURE,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for message repetitions during a random access channel (RACH) procedure.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes determining one or more of a mode of operation or an uplink-downlink channel reciprocity; and transmitting, to a network entity, a message 3 (Msg3) with repetitions during a random access channel (RACH) procedure based at least in part on one or more of the mode of operation or the uplink-downlink channel reciprocity.

In some aspects, a method of wireless communication performed by a network entity includes receiving, from a UE, a Msg3 with repetitions during a RACH procedure based at least in part on one or more of a mode of operation or an uplink-downlink channel reciprocity; and transmitting, to the UE, a connection setup message for establishing a connection between the network entity and the UE based at least in part on a successful decoding of the Msg3.

In some aspects, a UE for wireless communication includes a memory and one or more processors, coupled to the memory, configured to: determine one or more of a mode of operation or an uplink-downlink channel reciprocity; and transmit, to a network entity, a Msg3 with repetitions during a RACH procedure based at least in part on one or more of the mode of operation or the uplink-downlink channel reciprocity.

In some aspects, a network entity for wireless communication includes a memory and one or more processors, coupled to the memory, configured to: receive, from a UE, a Msg3 with repetitions during a RACH procedure based at least in part on one or more of a mode of operation or an uplink-downlink channel reciprocity; and transmit, to the UE, a connection setup message for establishing a connection between the network entity and the UE based at least in part on a successful decoding of the Msg3.

In some aspects, a non-transitory computer-readable medium storing a set of instructions for wireless communication includes one or more instructions that, when executed by one or more processors of a UE, cause the UE to: determine one or more of a mode of operation or an uplink-downlink channel reciprocity; and transmit, to a network entity, a Msg3 with repetitions during a RACH procedure based at least in part on one or more of the mode of operation or the uplink-downlink channel reciprocity.

In some aspects, a non-transitory computer-readable medium storing a set of instructions for wireless communication includes one or more instructions that, when executed by one or more processors of a network entity, cause the network entity to: receive, from a UE, a Msg3 with repetitions during a RACH procedure based at least in part on one or more of a mode of operation or an uplink-downlink channel reciprocity; and transmit, to the UE, a connection setup message for establishing a connection between the network entity and the UE based at least in part on a successful decoding of the Msg3.

In some aspects, an apparatus for wireless communication includes means for determining one or more of a mode of operation or an uplink-downlink channel reciprocity; and means for transmitting, to a network entity, a Msg3 with repetitions during a RACH procedure based at least in part on one or more of the mode of operation or the uplink-downlink channel reciprocity.

In some aspects, an apparatus for wireless communication includes means for receiving, from a UE, a Msg3 with repetitions during a RACH procedure based at least in part on one or more of a mode of operation or an uplink-downlink channel reciprocity; and means for transmitting, to the UE, a connection setup message for establishing a connection between the network entity and the UE based at least in part on a successful decoding of the Msg3.

Aspects generally include a method, apparatus, system, computer program product, non-transitory computer-readable medium, user equipment, network entity, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a four-step random access procedure, in accordance with the present disclosure.

FIG. 4 is a diagram illustrating examples of modes of operation, in accordance with the present disclosure.

FIG. 5 is a diagram illustrating an example associated with message repetitions during a random access channel (RACH) procedure, in accordance with the present disclosure.

FIGS. 6-7 are diagrams illustrating example processes associated with message repetitions during a RACH procedure, in accordance with the present disclosure.

FIGS. 8-9 are block diagrams of example apparatuses for wireless communication, in accordance with the present disclosure.

FIG. 10 is a diagram illustrating an example disaggregated base station architecture, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

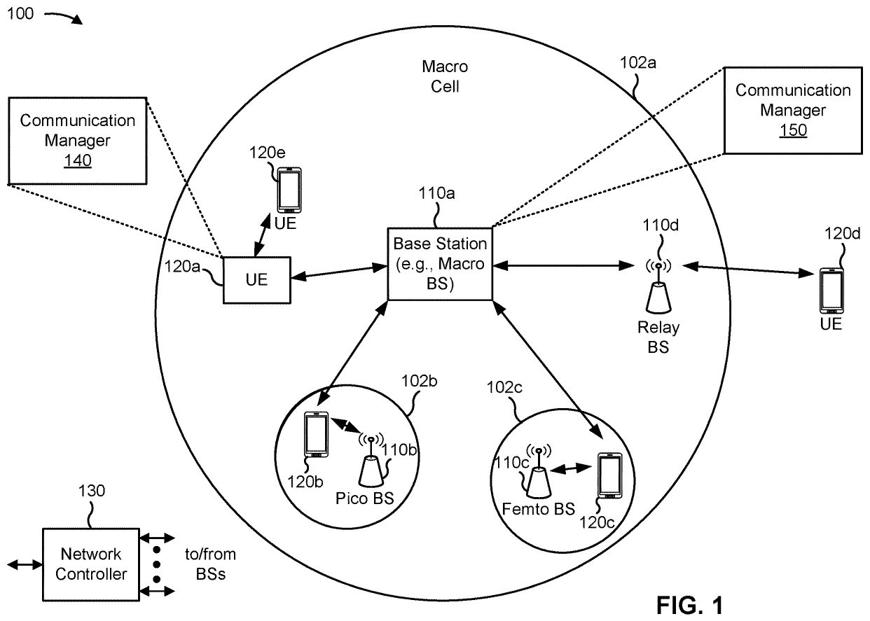

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may determine one or more of a mode of operation or an uplink-downlink channel reciprocity; and transmit, to a network entity, a message 3 (Msg3) with repetitions during a random access channel (RACH) procedure based at least in part on one or more of the mode of operation or the uplink-downlink channel reciprocity. Additionally, or alternatively, the communication manager 140 may perform one or more other operations described herein.

In some aspects, a network entity (e.g., base station 110) may include a communication manager 150. As described in more detail elsewhere herein, the communication manager 150 may receive, from a UE, a Msg3 with repetitions during a RACH procedure based at least in part on one or more of a mode of operation or an uplink-downlink channel reciprocity; and transmit, to the UE, a connection setup message for establishing a connection between the network entity and the UE based at least in part on a successful decoding of the Msg3. Additionally, or alternatively, the communication manager 150 may perform one or more other operations described herein.

As indicated above, FIG. 1 is provided as an example. Other examples may differ from what is described with regard to FIG. 1.

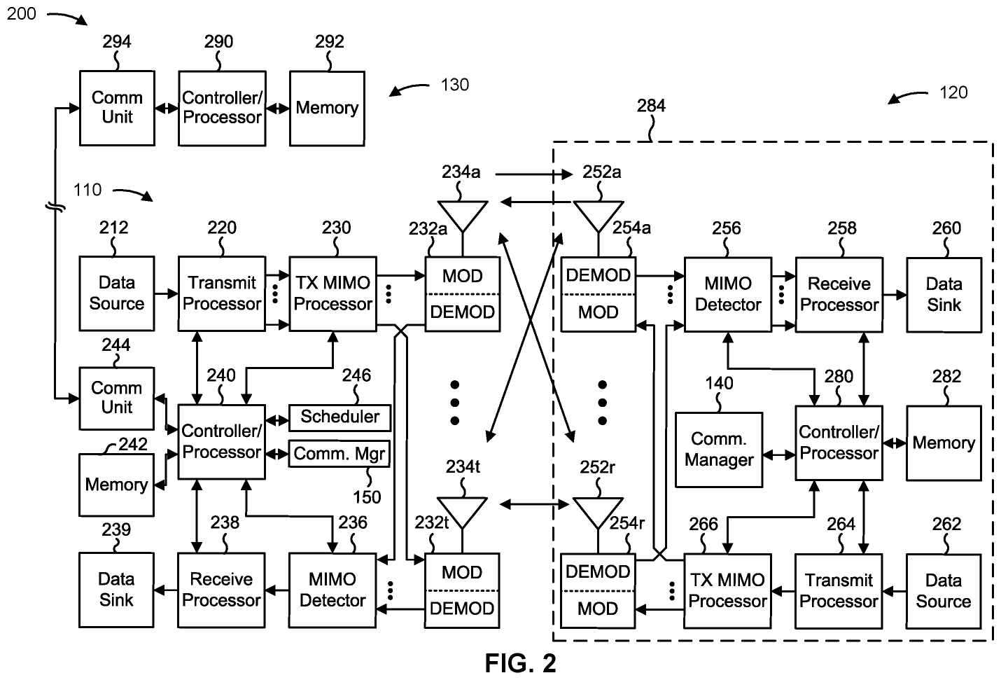

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

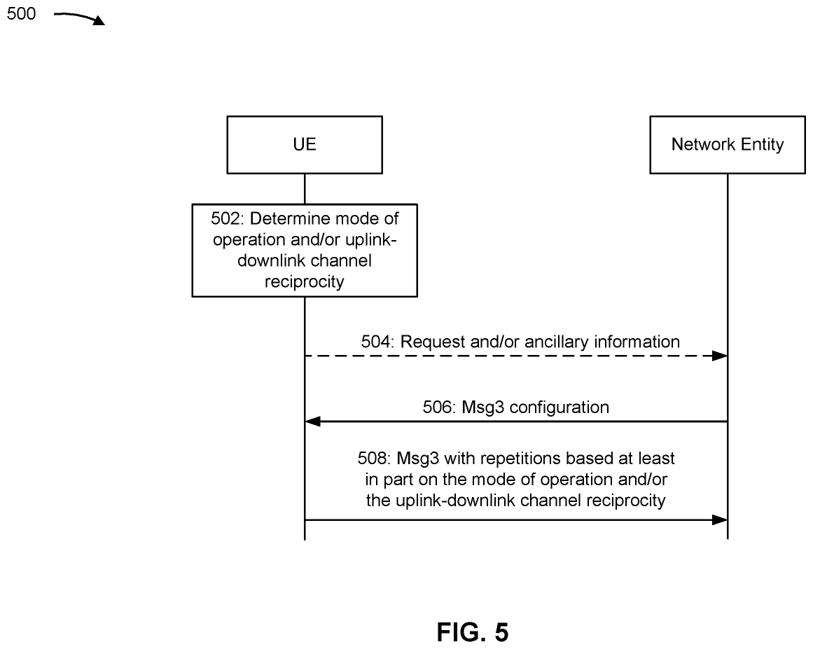

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-7).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-7).

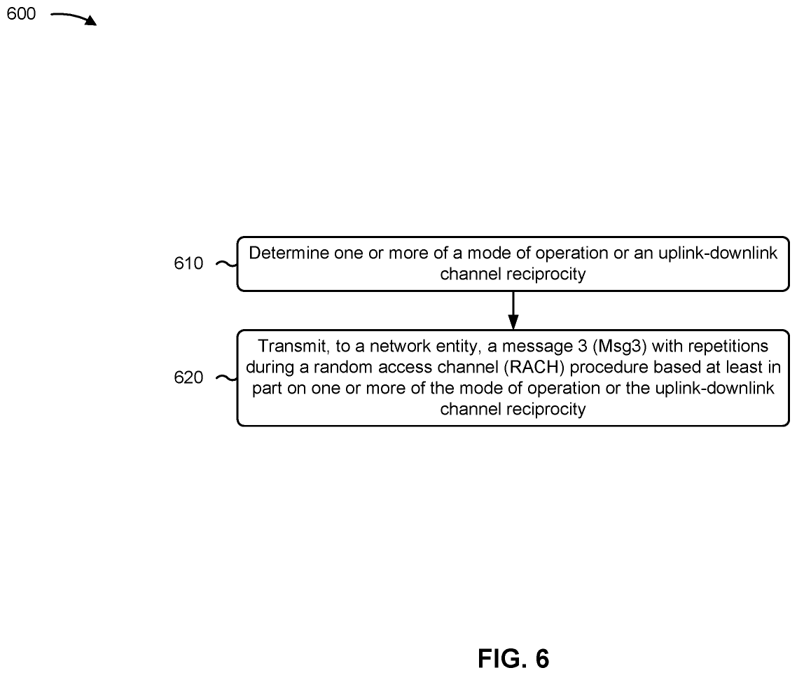

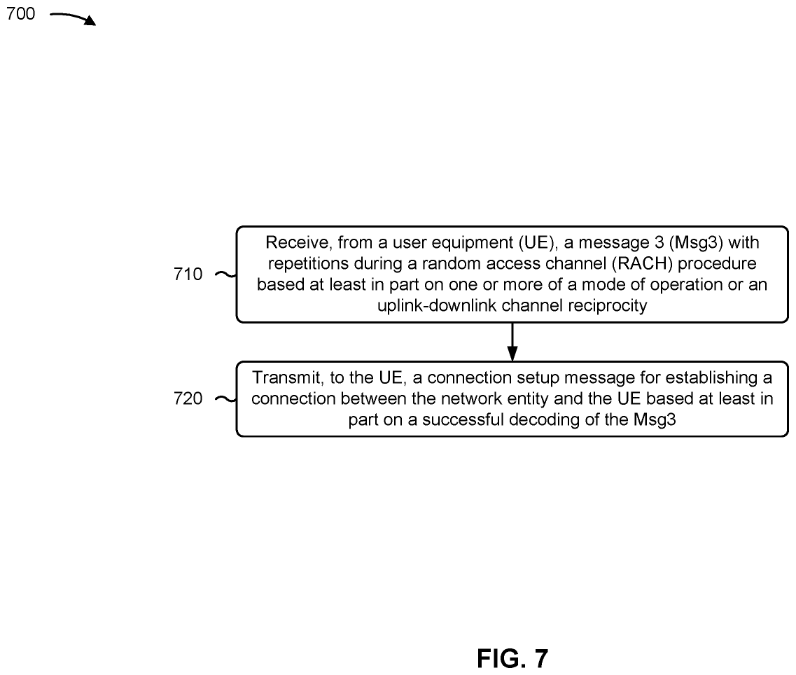

The controller/processor 240 of the base station 110, the controller/processor 280 of the UE 120, and/or any other component(s) of FIG. 2 may perform one or more techniques associated with message repetitions during a RACH procedure, as described in more detail elsewhere herein. For example, the controller/processor 240 of the base station 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, a UE (e.g., UE 120) includes means for determining one or more of a mode of operation or an uplink-downlink channel reciprocity; and/or means for transmitting, to a network entity, a Msg3 with repetitions during a RACH procedure based at least in part on one or more of the mode of operation or the uplink-downlink channel reciprocity. The means for the UE to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

In some aspects, a network entity (e.g., base station 110) includes means for receiving, from a UE, a Msg3 with repetitions during a RACH procedure based at least in part on one or more of a mode of operation or an uplink-downlink channel reciprocity; and/or means for transmitting, to the UE, a connection setup message for establishing a connection between the network entity and the UE based at least in part on a successful decoding of the Msg3. The means for the network entity to perform operations described herein may include, for example, one or more of communication manager 150, transmit processor 220, TX MIMO processor 230, modulator 232, antenna 234, demodulator 232, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

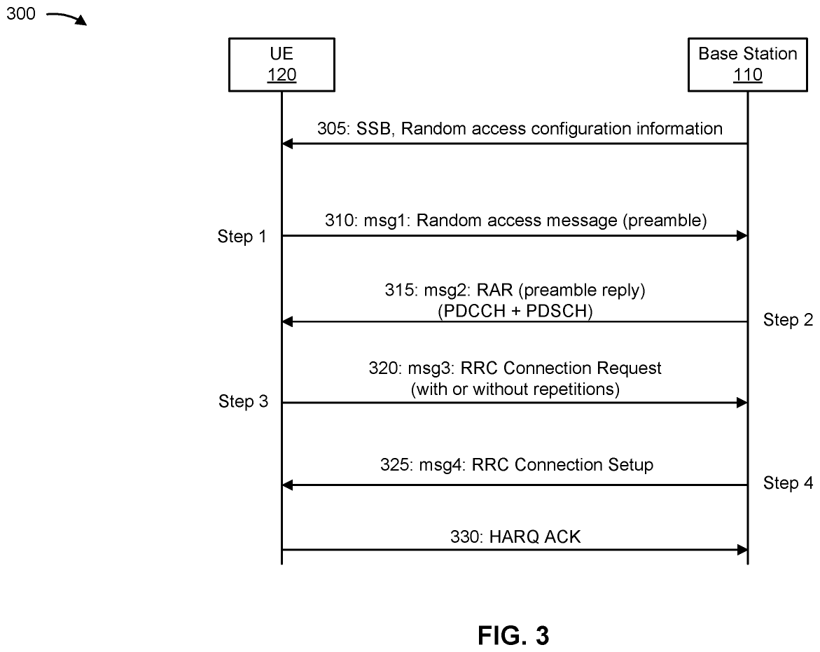

FIG. 3 is a diagram illustrating an example of a four-step random access procedure, in accordance with the present disclosure. As shown in FIG. 3, a base station 110 and a UE 120 may communicate with one another to perform the four-step random access procedure.

As shown by reference number 305, the base station 110 may transmit, and the UE 120 may receive, one or more synchronization signal blocks (SSBs) and random access configuration information. In some aspects, the random access configuration information may be transmitted in and/or indicated by system information (e.g., in one or more system information blocks (SIBs)) and/or an SSB, such as for contention-based random access. Additionally, or alternatively, the random access configuration information may be transmitted in a radio resource control (RRC) message and/or a physical downlink control channel (PDCCH) order message that triggers a RACH procedure, such as for contention-free random access. The random access configuration information may include one or more parameters to be used in the random access procedure, such as one or more parameters for transmitting a RAM and/or one or more parameters for receiving a random access response (RAR).

As shown by reference number 310, the UE 120 may transmit a RAM, which may include a preamble (sometimes referred to as a random access preamble, a physical random access channel (PRACH) preamble, or a RAM preamble). The message that includes the preamble may be referred to as a message 1, Msg1, a first message, or an initial message in a four-step random access procedure. The random access message may include a random access preamble identifier.

As shown by reference number 315, the base station 110 may transmit an RAR as a reply to the preamble. The message that includes the RAR may be referred to as message 2, Msg2, or a second message in a four-step random access procedure. In some aspects, the RAR may indicate the detected random access preamble identifier (e.g., received from the UE 120 in Msg1). Additionally, or alternatively, the RAR may indicate a resource allocation to be used by the UE 120 to transmit Msg3.

In some aspects, as part of the second step of the four-step random access procedure, the base station 110 may transmit a PDCCH communication for the RAR. The PDCCH communication may schedule a physical downlink shared channel (PDSCH) communication that includes the RAR. For example, the PDCCH communication may indicate a resource allocation for the PDSCH communication. Also as part of the second step of the four-step random access procedure, the base station 110 may transmit the PDSCH communication for the RAR, as scheduled by the PDCCH communication. The RAR may be included in a medium access control (MAC) packet data unit (PDU) of the PDSCH communication.

As shown by reference number 320, the UE 120 may transmit an RRC connection request message. The RRC connection request message may be referred to as message 3, Msg3, or a third message of a four-step random access procedure. In some aspects, the RRC connection request may include a UE identifier, uplink control information (UCI), and/or a physical uplink shared channel (PUSCH) communication (e.g., an RRC connection request). In some aspects, the UE 120 may transmit the Msg3 with or without repetitions depending on a mode of operation and/or an uplink-downlink channel reciprocity.

As shown by reference number 325, the base station 110 may transmit an RRC connection setup message. The RRC connection setup message may be referred to as message 4, Msg4, or a fourth message of a four-step random access procedure. In some aspects, the RRC connection setup message may include the detected UE identifier, a timing advance value, and/or contention resolution information. As shown by reference number 330, if the UE 120 successfully receives the RRC connection setup message, the UE 120 may transmit a hybrid automatic repeat request acknowledgement (HARQ ACK).

As indicated above, FIG. 3 is provided as an example. Other examples may differ from what is described with regard to FIG. 3.

In an updated four-step random access procedure, a UE may receive an SSB from a base station. The UE may perform a RACH transmission to the base station in a Msg1. The UE may implicitly indicate additional information as part of the RACH transmission. For example, the implicit information may indicate a quantity of repetitions needed for a Msg3. The implicit information, rather than directly indicating the quantity of repetitions needed for the Msg3, may include ancillary information that enables the base station to determine an appropriate quantity of repetitions for the Msg3. The implicit information may indicate a power headroom associated with the RACH transmission. The base station may receive, from the UE, the RACH transmission. The base station may decode the implicit information included in the RACH transmission. The base station may transmit a Msg2 to the UE, which may indicate grant information for the Msg3 and/or information regarding a quantity of repetitions for the Msg3. The UE may transmit, to the base station, the Msg3 with an appropriate quantity of repetitions based at least in part on the information indicated in the Msg2. The UE may transmit the Msg3 with repetitions as uplink transmissions.

Msg3 repetitions (e.g., Msg3 PUSCH repetitions) may be configured based at least in part on various options, including a first option, a second option, a third option, and a fourth option. In the first option and the second option, a base station may schedule Msg3 repetitions without UE input. In the third option and the fourth option, the base station may schedule Msg3 repetitions after receiving UE input.

In the first option, for a base station scheduled Msg3 repetition without a UE request, the UE may indicate a support of a Msg3 repetition via a separate PRACH occasion or a separate PRACH preamble in the case of shared PRACH occasions. For the UE supporting the Msg3 repetition, the base station may determine whether to schedule Msg3 repetitions, and if scheduled, the base station may determine a quantity of the Msg3 repetitions.

In the second option, for a base station scheduled Msg3 repetition without a UE request, the base station may determine whether to schedule Msg3 repetitions, and if scheduled, the base station may determine a quantity of the Msg3 repetitions. When the UE does not support the Msg3 repetition, the UE may transmit the Msg3 without repetition. When the UE does support the Msg3 repetition, the UE may transmit the Msg3 with repetition as indicated by the base station. The base station may blindly decode the Msg3 with two different assumptions, where a first assumption is with Msg3 repetition and a second assumption is without Msg3 repetition.

In the third option, for a UE triggered Msg3 repetition with a base station indicating a quantity of Msg3 repetitions, the UE may trigger a RACH procedure with a Msg3 repetition via a separate PRACH occasion or a separate PRACH preamble in the case of shared PRACH occasions. When the Msg3 repetition is triggered by the UE, the base station may determine a quantity of repetitions for a Msg3 (re)-transmission.

In the fourth option, for a UE triggered Msg3 repetition with a base station indicating a quantity of Msg3 repetitions, the base station may determine whether to schedule Msg3 repetitions, and if scheduled, the base station may determine a quantity of the Msg3 repetitions. When Msg3 repetition is scheduled, the UE may transmit the Msg3 with or without repetition. If the UE transmits the Msg3 with repetition, the quantity of the Msg3 repetitions may be based at least in part on an indication received from the base station.

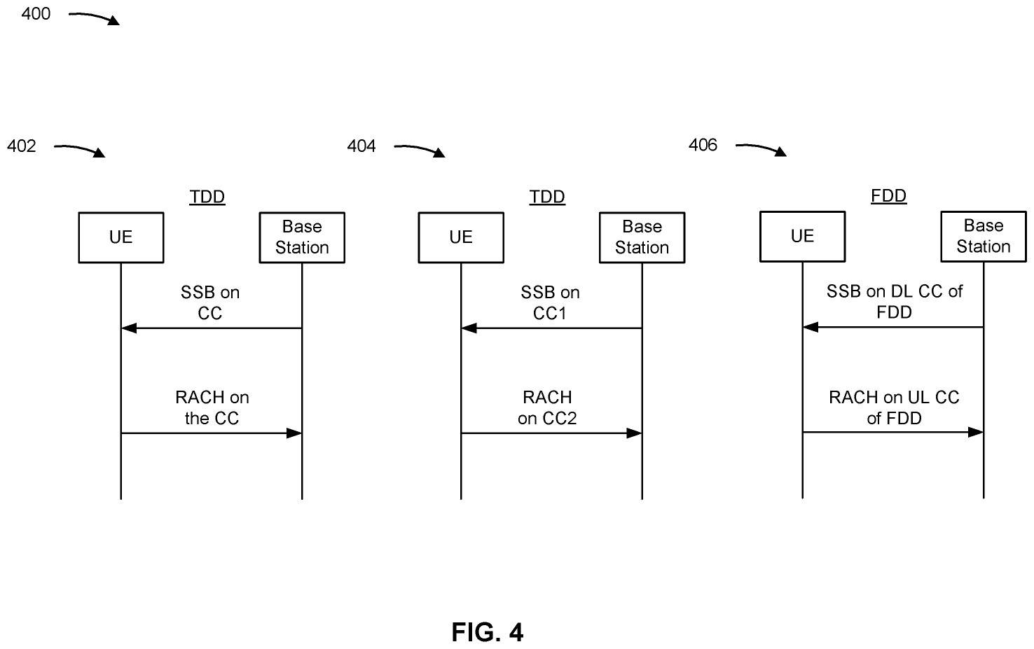

FIG. 4 is a diagram illustrating examples 400 of modes of operation, in accordance with the present disclosure.

As shown by reference number 402, a UE may operate in a time division duplexing (TDD) mode. A TDD mode of operation may be based at least in part on an unpaired spectrum. The UE may receive, from a base station, an SSB on a component carrier. The UE may receive the SSB on a downlink. The UE may transmit, to the base station, a RACH message on the component carrier. The UE may transmit the RACH message on an uplink. In this example, a same component carrier may be used for both downlink and uplink transmissions.

As shown by reference number 404, a UE may operate in a TDD mode. The UE may receive, from the base station, an SSB on a first component carrier (CC1). The UE may receive the SSB on a downlink. The UE may transmit, to the base station, a RACH message on a second component carrier (CC2). The UE may transmit the RACH message on an uplink. In this example, different component carriers may be used for downlink and uplink transmissions.

As shown by reference number 406, a UE may operate in a frequency division duplexing (FDD) mode. An FDD mode of operation may be based at least in part on a paired spectrum. The UE may receive, from a base station, an SSB on a downlink component carrier associated with FDD. The UE may receive the SSB on a downlink. The UE may transmit, to the base station, a RACH message on an uplink component carrier associated with FDD. The UE may transmit the RACH message on an uplink. In this example, a downlink component carrier may be used for downlink transmissions and an uplink component carrier may be used for uplink transmissions.

As indicated above, FIG. 4 is provided as an example. Other examples may differ from what is described with regard to FIG. 4.

A UE may determine whether a Msg3 is to be repeated (e.g., a need for Msg3 repetition) based at least in part on a transmit power used for transmitting the Msg3 to a base station. The transmit power used for transmitting the Msg3 may be derived from a transmit power used for transmitting a RACH in Msg1. Since the RACH transmission in Msg3 and the Msg3 transmission are both uplink transmissions, the transmit power associated with the RACH may correspond to the transmit power associated with the Msg3. The base station may indicate a transmit power offset (e.g., an offset of +6 dB or an offset of −3 dB), which may enable the UE to determine a maximum transmit power and a minimum transmit power to be used when transmitting Msg3. The base station may not receive or possess information regarding the transmit power used for transmitting the RACH in Msg1, and therefore may be unaware of an absolute power to be used by the UE for transmitting the Msg3.

The UE may determine whether the Msg3 is to be repeated (e.g., the need for Msg3 repetition) based at least in part on an uplink channel condition. The UE may be unable to directly measure the uplink channel condition, so the UE may infer an uplink channel quality based at least in part on other metrics, such as downlink channel measurements. The UE may measure a quality of an SSB reception. For example, the UE may perform SSB RSRP measurements based at least in part on the SSB received from the base station.

However, a downlink channel condition may not correspond to the uplink channel condition, depending on a mode of operation. In a TDD mode of operation, the downlink channel condition may correspond to the uplink channel condition based at least in part on an increased likelihood of an uplink-downlink channel reciprocity. The uplink-downlink channel reciprocity may be based at least in part on a channel condition of an uplink being similar to a channel condition of a downlink based at least in part on the uplink and the downlink being on same carriers or bands, contiguous carriers or bands, and so on. In an FDD mode of operation, the downlink channel condition may not correspond to the uplink channel condition based at least in part on a reduced likelihood of an uplink-downlink channel reciprocity. Further, in the TDD mode of operation but with the SSB being transmitted on one carrier or band and a RACH being transmitted on another carrier or band, the downlink channel condition may not correspond to the uplink channel condition based at least in part on a reduced likelihood of an uplink-downlink channel reciprocity. As a result, in some cases, the UE may be unable to accurately measure the uplink channel condition, so the UE may be unable to determine whether the Msg3 is to be repeated.

In various aspects of techniques and apparatuses described herein, a UE may determine a mode of operation and/or an uplink-downlink channel reciprocity. The mode of operation may be TDD with downlink transmissions and uplink transmissions being associated with a single component carrier. The mode of operation may be TDD with downlink transmissions and uplink transmissions being associated with different component carriers. The mode of operation may be FDD with downlink transmissions and uplink transmissions being associated with different component carriers. The uplink-downlink channel reciprocity may be present or not present between an uplink channel and a downlink channel. In other words, the UE may determine whether the uplink-downlink channel reciprocity is present between the uplink channel and the downlink channel.

The UE may determine whether the uplink-downlink channel reciprocity is present based at least in part on a proximity of uplink and downlink carriers when the uplink and downlink carriers are not the same. For example, when the uplink and downlink carriers are closer than X MHz, then a certain degree of uplink-downlink channel reciprocity may be assumed. Further, different degrees or levels of uplink-downlink channel reciprocity may be possible. For example, the uplink-downlink channel reciprocity may gradually decrease as component carriers move further away from each other.

In various aspects of techniques and apparatuses described herein, the UE may transmit, to a network entity (e.g., a base station), a Msg3 with repetitions during a RACH procedure based at least in part on the mode of operation and/or the uplink-downlink channel reciprocity. In other words, the UE may transmit the Msg3 with repetitions based at least in part on whether the mode of operation is TDD or FDD and/or an assumption of the uplink-downlink channel reciprocity. In some aspects, the repetitions may be UE-initiated Msg3 repetitions based at least in part on the mode of operation and/or the uplink-downlink channel reciprocity. In some aspects, the repetitions may be network entity initiated Msg3 repetitions based at least in part on the mode of operation and/or the uplink-downlink channel reciprocity. As a result, the UE may condition a Msg3 repetition procedure depending on the mode of operation and/or the uplink-downlink channel reciprocity, such that Msg3 repetitions may be implemented based at least in part on the mode of operation (e.g., TDD or FDD) and the uplink-downlink channel reciprocity.

FIG. 5 is a diagram illustrating an example 500 of message repetitions during a RACH procedure, in accordance with the present disclosure. As shown in FIG. 5, example 500 includes communication between the UE (e.g., UE 120) and a network entity (e.g., base station 110). In some aspects, the UE and the network entity may be included in a wireless network such as wireless network 100.

As shown by reference number 502, the UE may determine a mode of operation and/or an uplink-downlink channel reciprocity. In some aspects, the mode of operation may be a TDD mode that utilizes an unpaired spectrum. In the TDD mode, downlink transmissions and uplink transmissions may be associated with a single component carrier. Alternatively, in the TDD mode, downlink transmissions may be associated with a first component carrier, and uplink transmissions may be associated with a second component carrier. In some aspects, the mode of operation may be an FDD mode that utilizes a paired spectrum, where downlink transmissions may be associated with a downlink component carrier and uplink transmissions may be associated with an uplink component carrier.

In some aspects, the UE may determine whether the uplink-downlink channel reciprocity is applicable between an uplink channel and a downlink channel. In other words, the UE may determine whether an uplink channel condition may correspond a downlink channel condition based at least in part on the uplink-downlink channel reciprocity.

As shown by reference number 504, the UE may transmit a request for Msg3 repetitions to the network entity. The UE may transmit the request based at least in part on the mode of operation. For example, the UE may transmit the request when the mode of operation is TDD with a same component carrier for uplink and downlink transmissions, TDD with separate component carriers for uplink and downlink transmissions, or FDD with separate component carriers for uplink and downlink transmissions. In some aspects, the UE may transmit ancillary information to the network entity. The request and/or the ancillary information may enable the network entity to determine an appropriate quantity of repetitions for the Msg3, which may be conditioned on the mode of operation. In other words, the request and/or may enable the network entity to determine whether to configure Msg3 repetitions for the UE.

As shown by reference number 506, the UE may receive, from the network entity, a Msg3 configuration based at least in part on the request and/or the ancillary information. The UE may receive the Msg3 configuration in a Msg2 (or RAR). The Msg3 configuration may indicate a quantity of the Msg3 repetitions and other configuration information. In other words, the Msg3 configuration may indicate a granted quantity of Msg3 repetitions.

As shown by reference number 508, the UE may transmit, to the network entity, a Msg3 with repetitions during a RACH procedure. The UE may transmit the Msg3 with repetitions based at least in part on the mode of operation (e.g., TDD with a single component carrier for uplink and downlink transmissions, TDD with separate component carriers for uplink and downlink transmissions, or FDD with separate component carriers for uplink and downlink transmissions) and/or the uplink-downlink channel reciprocity (e.g., whether the uplink-downlink channel reciprocity is applicable between the uplink channel and the downlink channel). Further, the UE may transmit the Msg3 with repetitions based at least in part on the Msg3 configuration received from the network entity in the Msg2 (or RAR).

In some aspects, the repetitions may be UE-initiated Msg3 repetitions based at least in part on the mode of operation. For example, when the mode of operation is TDD with a single component carrier for uplink and downlink transmissions, the UE may initiate the Msg3 with repetitions. In this case, an uplink channel condition may be similar to a downlink channel condition since the same component carrier may be used for the uplink and downlink transmissions. As another example, when the mode of operation is TDD with separate component carriers for uplink and downlink transmissions, the UE may initiate the Msg3 with repetitions. As yet another example, when the mode of operation is FDD with separate component carriers for uplink and downlink transmissions, the UE may initiate the Msg3 with repetitions. The UE-initiated Msg3 repetitions may be permitted for TDD/FDD with separate component carriers for uplink and downlink transmissions when certain conditions are satisfied (e.g., conditions relating to whether an uplink-downlink channel reciprocity is present).

In some aspects, the UE may transmit, to the network entity, the request for Msg3 repetitions. In other words, the UE may provide input on Msg3 repetitions to the network entity. The UE may transmit the request in a Msg1 of the RACH procedure. Alternatively, the UE may transmit the request in the Msg3 of the RACH procedure. For example, the UE may transmit the request in the Msg3 based at least in part on an UCI multiplexing on a Msg3 PUSCH. As another example, the UE may transmit the request in the Msg3 using Msg3 PUSCH DMRS resources, such as DMRS sequences and/or DMRS ports. The network entity may receive the request and determine to grant Msg3 repetitions for the UE. The UE may receive, from the network entity, the Msg3 configuration that indicates a granted quantity of Msg3 repetitions based at least in part on the request. The network entity may transmit the Msg3 indication in the Msg2 (or RAR). The UE may transmit the Msg3 with repetitions to the network entity based at least in part on the Msg3 configuration received from the network entity.

In some aspects, the UE may transmit the request for Msg3 repetitions to the network entity based at least in part on the mode of operation and an ability to determine an uplink channel condition from a downlink channel condition due to the uplink-downlink channel reciprocity. The UE may transmit the request when the mode of operation is TDD with separate component carriers for uplink and downlink transmissions, or the mode of operation is FDD with separate component carriers for uplink and downlink transmissions. The UE may be able to infer the uplink channel condition based at least in part on the downlink channel condition, even though the uplink and downlink transmissions may be on two separate carriers. The UE may determine the downlink channel condition based at least in part on a receipt of an SSB from the network entity. The UE may be able to infer the uplink channel condition when the two separate carriers are contiguous carriers and are likely to exhibit similar channel conditions. The UE may transmit the request based at least in part on the uplink channel condition, which may be determined based at least in part on the uplink-downlink channel reciprocity.

In some aspects, the UE may determine a need for the Msg3 with repetitions based at least in part on the uplink channel condition. For example, the UE may determine that the uplink channel condition does not satisfy a threshold, so the UE may transmit the request for Msg3 repetitions to the network entity. The UE may determine a downlink channel condition based at least in part on an SSB received from the network entity. Depending on the mode of operation and/or the uplink-downlink channel reciprocity, the UE may be able to determine the uplink channel condition. Depending on the uplink channel condition (e.g., when the uplink channel condition does not satisfy the threshold), the UE may transmit the request for Msg3 repetitions to the network entity. An assumption of the uplink-downlink channel reciprocity may be based at least in part on the mode of operation. For example, a TDD mode of operation with a same component carrier for uplink and downlink transmissions may correspond to a presence of the uplink-downlink channel reciprocity. In some cases, a TDD or an FDD mode of operation with different component carriers for uplink and downlink transmissions may correspond to the presence of the uplink-downlink channel reciprocity. In these cases, the UE may be able to determine whether to request the Msg3 with repetitions.

In some aspects, the UE may receive, from the network entity, a RACH occasion configuration or an SSB RACH occasion mapping configuration that configures the UE for UE-initiated Msg3 repetitions. The RACH occasion configuration or the SSB RACH occasion mapping configuration may indicate to the UE that the UE is permitted to transmit the Msg3 with repetitions when certain events are satisfied based at least in part on the mode of operation and the uplink-downlink channel reciprocity. For example, the RACH occasion configuration or the SSB RACH occasion mapping configuration may indicate whether the UE is permitted to transmit the Msg3 with repetitions depending on the mode of operation and/or whether the uplink-downlink channel reciprocity is applicable between the uplink channel and the downlink channel.

In some aspects, the UE may transmit the request for Msg3 repetitions to the network entity based at least in part on the mode of operation irrespective of an ability or an inability to determine the uplink channel condition from the downlink channel condition due to a lack of uplink-downlink channel reciprocity but when another condition is satisfied. The UE may transmit the request for Msg3 repetitions when the mode of operation is TDD with separate component carriers for uplink and downlink transmissions, or the mode of operation is FDD with separate component carriers for uplink and downlink transmissions. Even though the uplink-downlink channel reciprocity may not be present (e.g., a channel coupling cannot be established), the UE may transmit the request when the other condition is satisfied. For example, the UE may transmit the request based at least in part on a transmit power for a Msg1 of the RACH satisfying a threshold. As another example, the UE may transmit the request the based at least in part on a Msg1 of the RACH procedure being transmitted to the network entity with repetitions. As yet another example, the UE may transmit the request based at least in part on an SSB RSRP measurement not satisfying a threshold level. In other words, the condition may be satisfied when the Msg1 transmit power is already maximized, when Msg1 repetitions are used, and/or when the SSB RSRP measurement does not satisfy the threshold level, and in these cases, the UE may transmit the request for Msg3 repetitions even with the lack of uplink-downlink channel reciprocity.

In some aspects, the repetitions may be network entity initiated Msg3 repetitions based at least in part on the mode of operation. For example, when the mode of operation is TDD with separate component carriers for uplink and downlink transmissions, the network entity may initiate the transmission of the Msg3 with repetitions. As another example, when the mode of operation is FDD with separate component carriers for uplink and downlink transmissions, the network entity may initiate the transmission of the Msg3 with repetitions. In these cases, the network entity may transmit the Msg3 configuration, to the UE, that grants a quantity of Msg3 repetitions. The UE may transmit the Msg3 with repetitions to the network entity based at least in part on the Msg3 configuration received from the network entity. In other words, in this example, the network entity may determine whether the Msg3 is to be repeated without receiving a request for Msg3 repetitions from the UE.

In some aspects, the network entity may determine whether the Msg3 is to be repeated based at least in part on the ancillary information received from the UE. The ancillary information may indicate a transmit power of the Msg1 during the RACH procedure and/or a power headroom indicating additional power available in relation to the transmit power of the Msg1. The UE may transmit the ancillary information based at least in part on a UCI multiplexing on a Msg3 PUSCH, or alternatively, the UE may transmit the ancillary information using Msg3 PUSCH DMRS resources (e.g., DMRS sequences and/or DMRS ports). The network entity may determine, based at least in part on the ancillary information, whether to initiate Msg3 repetitions for the UE. The network entity may transmit, to the UE, the Msg3 configuration that indicates the granted quantity of Msg3 repetitions based at least in part on the ancillary information received from the UE.

As indicated above, FIG. 5 is provided as an example. Other examples may differ from what is described with regard to FIG. 5.

FIG. 6 is a diagram illustrating an example process 600 performed, for example, by a UE, in accordance with the present disclosure. Example process 600 is an example where the UE (e.g., UE 120) performs operations associated with message repetitions during a RACH procedure.

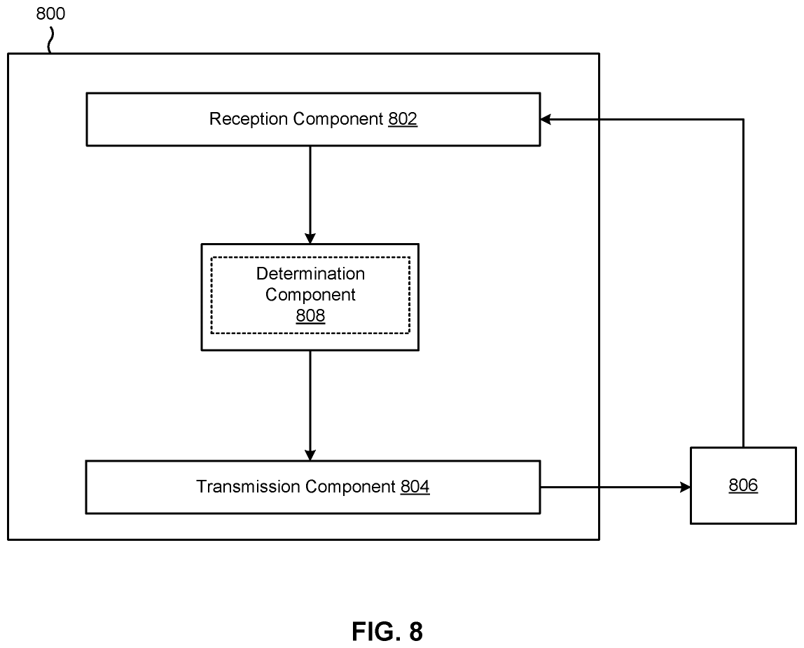

As shown in FIG. 6, in some aspects, process 600 may include determining one or more of a mode of operation or an uplink-downlink channel reciprocity (block 610). For example, the UE (e.g., using determination component 808, depicted in FIG. 8) may determine one or more of a mode of operation or an uplink-downlink channel reciprocity, as described above.

As further shown in FIG. 6, in some aspects, process 600 may include transmitting, to a network entity, a Msg3 with repetitions during a RACH procedure based at least in part on one or more of the mode of operation or the uplink-downlink channel reciprocity (block 620). For example, the UE (e.g., using transmission component 804, depicted in FIG. 8) may transmit, to a network entity, a Msg3 with repetitions during a RACH procedure based at least in part on one or more of the mode of operation or the uplink-downlink channel reciprocity, as described above.

Process 600 may include additional aspects, such as any single aspect or any combination of aspects described below and/or in connection with one or more other processes described elsewhere herein.

In a first aspect, the mode of operation is a TDD mode that utilizes an unpaired spectrum, and wherein downlink transmissions and uplink transmissions are associated with a single component carrier.

In a second aspect, alone or in combination with the first aspect, the mode of operation is a TDD mode that utilizes an unpaired spectrum, and wherein downlink transmissions are associated with a first component carrier and uplink transmissions are associated with a second component carrier.

In a third aspect, alone or in combination with one or more of the first and second aspects, the mode of operation is an FDD mode that utilizes a paired spectrum, and wherein downlink transmissions are associated with a downlink component carrier and uplink transmissions are associated with an uplink component carrier.

In a fourth aspect, alone or in combination with one or more of the first through third aspects, the repetitions are UE-initiated Msg3 repetitions based at least in part on the mode of operation, wherein the mode of operation is a time division duplexing mode in which downlink transmissions and uplink transmissions are associated with a single component carrier or separate component carriers, or the mode of operation is a frequency division duplexing mode in which downlink transmissions and uplink transmissions are associated with separate component carriers.

In a fifth aspect, alone or in combination with one or more of the first through fourth aspects, process 600 includes transmitting, to the network entity, a request for Msg3 repetitions when the repetitions are UE-initiated Msg3 repetitions based at least in part on the mode of operation, and receiving, from the network entity, an indication that indicates a granted quantity of Msg3 repetitions based at least in part on the request.

In a sixth aspect, alone or in combination with one or more of the first through fifth aspects, process 600 includes transmitting the request in a Msg1 of the RACH procedure.

In a seventh aspect, alone or in combination with one or more of the first through sixth aspects, process 600 includes transmitting the request in the Msg3 of the RACH procedure.

In an eighth aspect, alone or in combination with one or more of the first through seventh aspects, process 600 includes determining an uplink channel condition from a downlink channel condition based at least in part on the uplink-downlink channel reciprocity, wherein downlink transmissions are associated with a first component carrier and uplink transmissions are associated with a second component carrier based at least in part on the mode of operation, and transmitting the Msg3 with repetitions is based at least in part on the uplink channel condition.

In a ninth aspect, alone or in combination with one or more of the first through eighth aspects, process 600 includes receiving, from the network entity, a RACH occasion configuration or an SSB RACH occasion mapping configuration that configures the UE for UE-initiated Msg3 repetitions.

In a tenth aspect, alone or in combination with one or more of the first through ninth aspects, process 600 includes transmitting, to the network entity, a request for Msg3 repetitions based at least in part on the mode of operation when downlink transmissions are associated with a first component carrier and uplink transmissions are associated with a second component carrier based at least in part on the mode of operation.

In an eleventh aspect, alone or in combination with one or more of the first through tenth aspects, transmitting the request for Msg3 repetitions is based at least in part on a transmit power for a Msg1 of the RACH procedure satisfying a threshold.

In a twelfth aspect, alone or in combination with one or more of the first through eleventh aspects, transmitting the request for Msg3 repetitions is based at least in part on a Msg1 of the RACH procedure being transmitted to the network entity with repetitions.

In a thirteenth aspect, alone or in combination with one or more of the first through twelfth aspects, transmitting the request for Msg3 repetitions is based at least in part on an SSB RSRP not satisfying a threshold level.

In a fourteenth aspect, alone or in combination with one or more of the first through thirteenth aspects, the repetitions are network entity initiated Msg3 repetitions based at least in part on the mode of operation.

In a fifteenth aspect, alone or in combination with one or more of the first through fourteenth aspects, process 600 includes transmitting the Msg3 with repetitions without transmitting a request for Msg3 repetitions to the network entity when the repetitions are network entity initiated Msg3 repetitions based at least in part on the mode of operation.

In a sixteenth aspect, alone or in combination with one or more of the first through fifteenth aspects, process 600 includes transmitting, to the network entity, a first indication that indicates one or more of a transmit power of a Msg1 during the RACH procedure or a power headroom indicating additional power available in relation to the transmit power of the Msg1, when the repetitions are network entity initiated Msg3 repetitions based at least in part on the mode of operation, and receiving, from the network entity, a second indication that indicates a granted quantity of Msg3 repetitions based at least in part on the first indication.

In a seventeenth aspect, alone or in combination with one or more of the first through sixteenth aspects, process 600 includes transmitting the first indication based at least in part on a UCI multiplexing on a Msg3 PUSCH.

In an eighteenth aspect, alone or in combination with one or more of the first through seventeenth aspects, process 600 includes transmitting the first indication using Msg3 PUSCH DMRS resources.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network entity, in accordance with the present disclosure. Example process 700 is an example where the network entity (e.g., base station 110) performs operations associated with message repetitions during a RACH procedure.

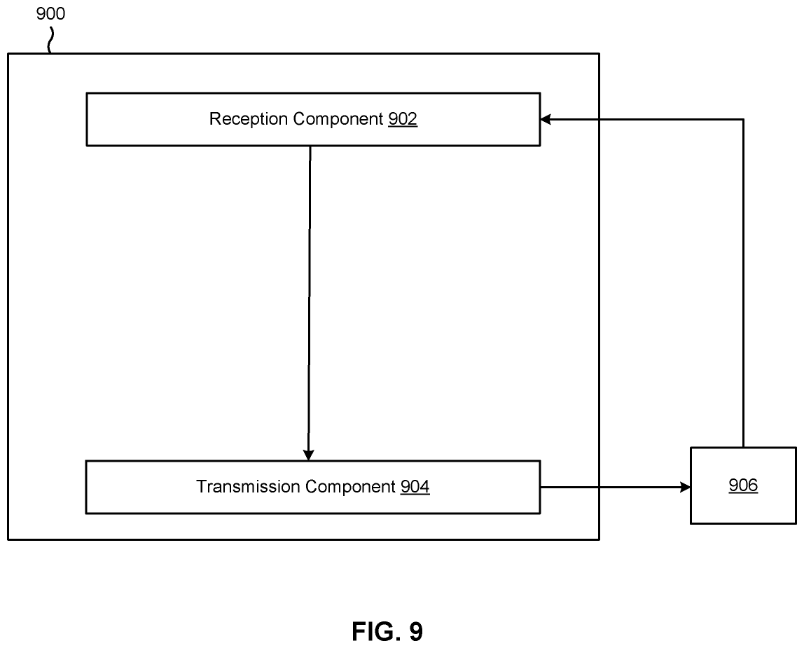

As shown in FIG. 7, in some aspects, process 700 may include receiving, from a UE, a Msg3 with repetitions during a RACH procedure based at least in part on one or more of a mode of operation or an uplink-downlink channel reciprocity (block 710). For example, the network entity (e.g., using reception component 902, depicted in FIG. 9) may receive, from a UE, a Msg3 with repetitions during a RACH procedure based at least in part on one or more of a mode of operation or an uplink-downlink channel reciprocity, as described above.

As further shown in FIG. 7, in some aspects, process 700 may include transmitting, to the UE, a connection setup message for establishing a connection between the network entity and the UE based at least in part on a successful decoding of the Msg3 (block 720). For example, the network entity (e.g., using transmission component 904, depicted in FIG. 9) may transmit, to the UE, a connection setup message for establishing a connection between the network entity and the UE based at least in part on a successful decoding of the Msg3, as described above.

Process 700 may include additional aspects, such as any single aspect or any combination of aspects described below and/or in connection with one or more other processes described elsewhere herein.

In a first aspect, the mode of operation is a TDD mode that utilizes an unpaired spectrum, and wherein downlink transmissions and uplink transmissions are associated with a single component carrier.

In a second aspect, alone or in combination with the first aspect, the mode of operation is a TDD mode that utilizes an unpaired spectrum, and wherein downlink transmissions are associated with a first component carrier and uplink transmissions are associated with a second component carrier.

In a third aspect, alone or in combination with one or more of the first and second aspects, the mode of operation is an FDD mode that utilizes a paired spectrum, and wherein downlink transmissions are associated with a downlink component carrier and uplink transmissions are associated with an uplink component carrier.

In a fourth aspect, alone or in combination with one or more of the first through third aspects, the repetitions are UE-initiated Msg3 repetitions based at least in part on the mode of operation, wherein the mode of operation is a time division duplexing mode in which downlink transmissions and uplink transmissions are associated with a single component carrier or separate component carriers, or the mode of operation is a frequency division duplexing mode in which downlink transmissions and uplink transmissions are associated with separate component carriers.

In a fifth aspect, alone or in combination with one or more of the first through fourth aspects, process 700 includes receiving, from the UE, a request for Msg3 repetitions when the repetitions are UE-initiated Msg3 repetitions based at least in part on the mode of operation, and transmitting, to the UE, an indication that indicates a granted quantity of Msg3 repetitions based at least in part on the request.

In a sixth aspect, alone or in combination with one or more of the first through fifth aspects, process 700 includes receiving the request in a Msg1 of the RACH procedure.

In a seventh aspect, alone or in combination with one or more of the first through sixth aspects, process 700 includes receiving the request in the Msg3 of the RACH procedure.

In an eighth aspect, alone or in combination with one or more of the first through seventh aspects, process 700 includes comprises receiving the Msg3 with repetitions based at least in part on an uplink channel condition, wherein the uplink channel condition is determined from a downlink channel condition based at least in part on the uplink-downlink channel reciprocity, and wherein downlink transmissions are associated with a first component carrier and uplink transmissions are associated with a second component carrier based at least in part on the mode of operation.

In a ninth aspect, alone or in combination with one or more of the first through eighth aspects, process 700 includes transmitting, to the UE, a RACH occasion configuration or an SSB RACH occasion mapping configuration that configures the UE for UE-initiated Msg3 repetitions.

In a tenth aspect, alone or in combination with one or more of the first through ninth aspects, process 700 includes receiving, from the UE, a request for Msg3 repetitions based at least in part on the mode of operation when downlink transmissions are associated with a first component carrier and uplink transmissions are associated with a second component carrier based at least in part on the mode of operation.

In an eleventh aspect, alone or in combination with one or more of the first through tenth aspects, receiving the request for Msg3 repetitions is based at least in part on a transmit power for a Msg1 of the RACH procedure satisfying a threshold.

In a twelfth aspect, alone or in combination with one or more of the first through eleventh aspects, receiving the request for Msg3 repetitions is based at least in part on a Msg1 of the RACH procedure being received from the UE with repetitions.

In a thirteenth aspect, alone or in combination with one or more of the first through twelfth aspects, receiving the request for Msg3 repetitions is based at least in part on an SSB RSRP measurement not satisfying a threshold level.

In a fourteenth aspect, alone or in combination with one or more of the first through thirteenth aspects, the repetitions are network entity initiated Msg3 repetitions based at least in part on the mode of operation.

In a fifteenth aspect, alone or in combination with one or more of the first through fourteenth aspects, process 700 includes receiving the Msg3 with repetitions without receiving a request for Msg3 repetitions from the UE when the repetitions are network entity initiated Msg3 repetitions based at least in part on the mode of operation.

In a sixteenth aspect, alone or in combination with one or more of the first through fifteenth aspects, process 700 includes receiving, from the UE, a first indication that indicates one or more of a transmit power of a Msg1 during the RACH procedure or a power headroom indicating additional power available in relation to the transmit power of the Msg1, when the repetitions are network entity initiated Msg3 repetitions based at least in part on the mode of operation, and transmitting, to the UE, a second indication that indicates a granted quantity of Msg3 repetitions based at least in part on the first indication.

In a seventeenth aspect, alone or in combination with one or more of the first through sixteenth aspects, process 700 includes receiving the first indication based at least in part on a UCI multiplexing on a Msg3 PUSCH.

In an eighteenth aspect, alone or in combination with one or more of the first through seventeenth aspects, process 700 includes receiving the first indication using Msg3 PUSCH DMRS resources.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a block diagram of an example apparatus 800 for wireless communication. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include a determination component 808, among other examples.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described above in connection with FIG. 2. Additionally, or alternatively, one or more components shown in FIG. 8 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a demodulator, a MIMO detector, a receive processor, a controller/processor, a memory, or a combination thereof, of the UE described above in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modulator, a transmit MIMO processor, a transmit processor, a controller/processor, a memory, or a combination thereof, of the UE described above in connection with FIG. 2. In some aspects, the transmission component 804 may be co-located with the reception component 802 in a transceiver.

The determination component 808 may determine one or more of a mode of operation or an uplink-downlink channel reciprocity. The transmission component 804 may transmit, to a network entity, a Msg3 with repetitions during a RACH procedure based at least in part on one or more of the mode of operation or the uplink-downlink channel reciprocity.

The transmission component 804 may transmit, to the network entity, a request for Msg3 repetitions. The reception component 802 may receive, from the network entity, an indication that indicates a granted quantity of Msg3 repetitions based at least in part on the request. The determination component 808 may determine an uplink channel condition from a downlink channel condition based at least in part on the uplink-downlink channel reciprocity. The reception component 802 may receive, from the network entity, a RACH occasion configuration or an SSB RACH occasion mapping configuration that configures the UE for UE-initiated Msg3 repetitions.

The transmission component 804 may transmit, to the network entity, a request for Msg3 repetitions based at least in part on the mode of operation. The transmission component 804 may transmit, to the network entity, a first indication that indicates one or more of a transmit power of a Msg1 during the RACH procedure or a power headroom indicating additional power available in relation to the transmit power of the Msg1. The reception component 802 may receive, from the network entity, a second indication that indicates a granted quantity of Msg3 repetitions based at least in part on the first indication.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a block diagram of an example apparatus 900 for wireless communication. The apparatus 900 may be a network entity, or a network entity may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the base station described above in connection with FIG. 2. Additionally, or alternatively, one or more components shown in FIG. 9 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a demodulator, a MIMO detector, a receive processor, a controller/processor, a memory, or a combination thereof, of the base station described above in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modulator, a transmit MIMO processor, a transmit processor, a controller/processor, a memory, or a combination thereof, of the base station described above in connection with FIG. 2. In some aspects, the transmission component 904 may be co-located with the reception component 902 in a transceiver.

The reception component 902 may receive, from a UE, a Msg3 with repetitions during a RACH procedure based at least in part on one or more of a mode of operation or an uplink-downlink channel reciprocity. The transmission component 904 may transmit, to the UE, a connection setup message for establishing a connection between the network entity and the UE based at least in part on a successful decoding of the Msg3.

The reception component 902 may receive, from the UE, a request for Msg3 repetitions. The transmission component 904 may transmit, to the UE, an indication that indicates a granted quantity of Msg3 repetitions based at least in part on the request. The transmission component 904 may transmit, to the UE, a RACH occasion configuration or an SSB RACH occasion mapping configuration that configures the UE for UE-initiated Msg3 repetitions.

The reception component 902 may receive, from the UE, a request for Msg3 repetitions based at least in part on the mode of operation and an inability of the UE to determine an uplink channel condition from a downlink channel condition due to a lack of the uplink-downlink channel reciprocity. The reception component 902 may receive, from the UE, a first indication that indicates one or more of a transmit power of a Msg1 during the RACH procedure or a power headroom indicating additional power available in relation to the transmit power of the Msg1. The transmission component 904 may transmit, to the UE, a second indication that indicates a granted quantity of Msg3 repetitions based at least in part on the first indication.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

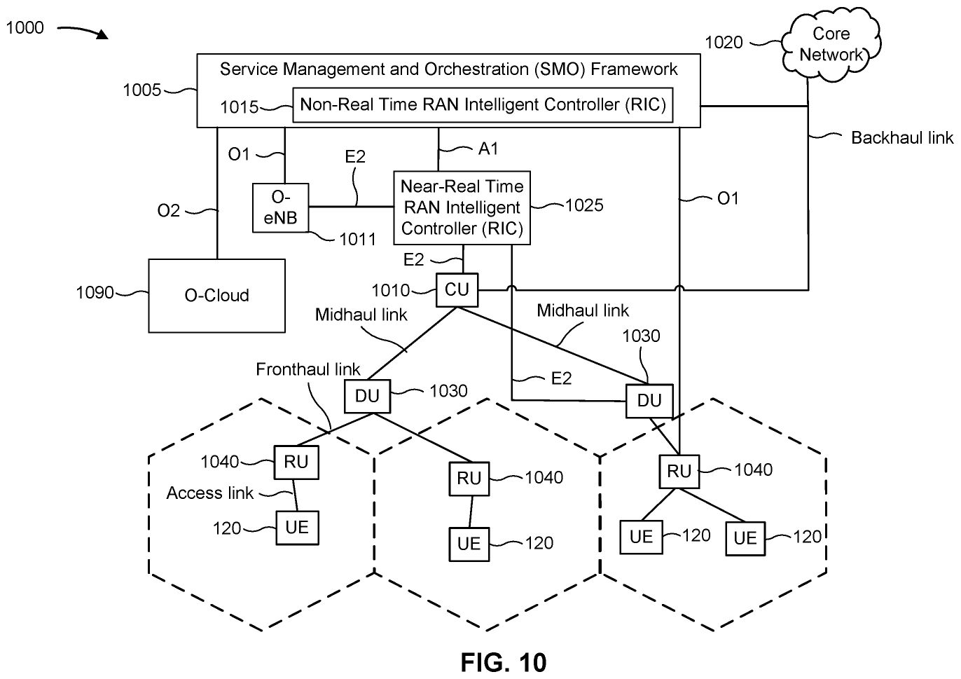

FIG. 10 is a diagram illustrating an example 1000 disaggregated base station architecture, in accordance with the present disclosure.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs. In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an IAB network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 10 may include one or more CUs 1010 that can communicate directly with a core network 1020 via a backhaul link, or indirectly with the core network 1020 through one or more disaggregated base station units (such as a Near-Real Time (Near-RT) RAN Intelligent Controller (MC) 1025 via an E2 link, or a Non-Real Time (Non-RT) RIC 1015 associated with a Service Management and Orchestration (SMO) Framework 1005, or both). A CU 1010 may communicate with one or more DUs 1030 via respective midhaul links, such as an F1 interface. The DUs 1030 may communicate with one or more RUs 1040 via respective fronthaul links. The RUs 1040 may communicate with respective UEs 120 via one or more radio frequency (RF) access links. In some implementations, the UE 120 may be simultaneously served by multiple RUs 1040.

Each of the units (e.g., the CUs 1010, the DUs 1030, the RUs 1040), as well as the Near-RT RICs 1025, the Non-RT RICs 1015, and the SMO Framework 1005, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 1010 may host one or more higher layer control functions. Such control functions can include RRC, packet data convergence protocol (PDCP), service data adaptation protocol (SDAP), or the like. Each control function can be implemented with an interface configured to communicate signals with other control functions hosted by the CU 1010. The CU 1010 may be configured to handle user plane functionality (e.g., Central Unit-User Plane (CU-UP)), control plane functionality (e.g., Central Unit-Control Plane (CU-CP)), or a combination thereof. In some implementations, the CU 1010 can be logically split into one or more CU-UP units and one or more CU-CP units. The CU-UP unit can communicate bidirectionally with the CU-CP unit via an interface, such as the E1 interface when implemented in an O-RAN configuration. The CU 1010 can be implemented to communicate with the DU 1030, as necessary, for network control and signaling.

The DU 1030 may correspond to a logical unit that includes one or more base station functions to control the operation of one or more RUs 1040. In some aspects, the DU 1030 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 1030 may further host one or more low-PHY layers. Each layer (or module) can be implemented with an interface configured to communicate signals with other layers (and modules) hosted by the DU 1030, or with the control functions hosted by the CU 1010.

Lower-layer functionality can be implemented by one or more RUs 1040. In some deployments, an RU 1040, controlled by a DU 1030, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 1040 can be implemented to handle over the air (OTA) communication with one or more UEs 120. In some implementations, real-time and non-real-time aspects of control and user plane communication with the RU(s) 1040 can be controlled by the corresponding DU 1030. In some scenarios, this configuration can enable the DU(s) 1030 and the CU 1010 to be implemented in a cloud-based RAN architecture, such as a vRAN architecture.

The SMO Framework 1005 may be configured to support RAN deployment and provisioning of non-virtualized and virtualized network elements. For non-virtualized network elements, the SMO Framework 1005 may be configured to support the deployment of dedicated physical resources for RAN coverage requirements which may be managed via an operations and maintenance interface (such as an O1 interface). For virtualized network elements, the SMO Framework 1005 may be configured to interact with a cloud computing platform (such as an open cloud (O-Cloud) 1090) to perform network element life cycle management (such as to instantiate virtualized network elements) via a cloud computing platform interface (such as an O2 interface). Such virtualized network elements can include, but are not limited to, CUs 1010, DUs 1030, RUs 1040 and Near-RT RICs 1025. In some implementations, the SMO Framework 1005 can communicate with a hardware aspect of a 4G RAN, such as an open eNB (O-eNB) 1111, via an O1 interface. Additionally, in some implementations, the SMO Framework 1005 can communicate directly with one or more RUs 1040 via an O1 interface. The SMO Framework 1005 also may include a Non-RT RIC 1015 configured to support functionality of the SMO Framework 1005.

The Non-RT RIC 1015 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 1025. The Non-RT RIC 1015 may be coupled to or communicate with (such as via an A1 interface) the Near-RT RIC 1025. The Near-RT RIC 1025 may be configured to include a logical function that enables near-real-time control and optimization of RAN elements and resources via data collection and actions over an interface (such as via an E2 interface) connecting one or more CUs 1010, one or more DUs 1030, or both, as well as an O-eNB, with the Near-RT RIC 1025.

In some implementations, to generate AI/ML models to be deployed in the Near-RT RIC 1025, the Non-RT RIC 1015 may receive parameters or external enrichment information from external servers. Such information may be utilized by the Near-RT RIC 1025 and may be received at the SMO Framework 1005 or the Non-RT RIC 1015 from non-network data sources or from network functions. In some examples, the Non-RT RIC 1015 or the Near-RT RIC 1025 may be configured to tune RAN behavior or performance. For example, the Non-RT RIC 1015 may monitor long-term trends and patterns for performance and employ AI/ML models to perform corrective actions through the SMO Framework 1005 (such as reconfiguration via 01) or via creation of RAN management policies (such as A1 policies).

As indicated above, FIG. 10 is provided as an example. Other examples may differ from what is described with regard to FIG. 10.

The following provides an overview of some Aspects of the present disclosure:

Aspect 1: A method of wireless communication performed by a user equipment (UE), comprising: determining one or more of a mode of operation or an uplink-downlink channel reciprocity; and transmitting, to a network entity, a message 3 (Msg3) with repetitions during a random access channel (RACH) procedure based at least in part on one or more of the mode of operation or the uplink-downlink channel reciprocity.

Aspect 2: The method of Aspect 1, wherein the mode of operation is a time division duplexing mode that utilizes an unpaired spectrum, and wherein downlink transmissions and uplink transmissions are associated with a single component carrier.

Aspect 3: The method of any of Aspects 1 through 2, wherein the mode of operation is a time division duplexing mode that utilizes an unpaired spectrum, and wherein downlink transmissions are associated with a first component carrier and uplink transmissions are associated with a second component carrier.

Aspect 4: The method of any of Aspects 1 through 3, wherein the mode of operation is a frequency division duplexing mode that utilizes a paired spectrum, and wherein downlink transmissions are associated with a downlink component carrier and uplink transmissions are associated with an uplink component carrier.

Aspect 5: The method of any of Aspects 1 through 4, wherein the repetitions are UE-initiated Msg3 repetitions based at least in part on the mode of operation, wherein the mode of operation is a time division duplexing mode in which downlink transmissions and uplink transmissions are associated with a single component carrier or separate component carriers, or the mode of operation is a frequency division duplexing mode in which downlink transmissions and uplink transmissions are associated with separate component carriers.

Aspect 6: The method of Aspect 5, further comprising: transmitting, to the network entity, a request for Msg3 repetitions when the repetitions are UE-initiated Msg3 repetitions based at least in part on the mode of operation; and receiving, from the network entity, an indication that indicates a granted quantity of Msg3 repetitions based at least in part on the request.

Aspect 7: The method of Aspect 6, wherein transmitting the request for Msg3 repetitions comprises transmitting the request in a message 1 of the RACH procedure.

Aspect 8: The method of Aspect 6, wherein transmitting the request for Msg3 repetitions comprises transmitting the request in the Msg3 of the RACH procedure.

Aspect 9: The method of any of Aspects 1 through 8, further comprising: determining an uplink channel condition from a downlink channel condition based at least in part on the uplink-downlink channel reciprocity, wherein downlink transmissions are associated with a first component carrier and uplink transmissions are associated with a second component carrier based at least in part on the mode of operation, and wherein transmitting the Msg3 with repetitions is based at least in part on the uplink channel condition.

Aspect 10: The method of any of Aspects 1 through 9, further comprising: receiving, from the network entity, a RACH occasion configuration or a synchronization signal block to RACH occasion mapping configuration that configures the UE for UE-initiated Msg3 repetitions.

Aspect 11: The method of any of Aspects 1 through 10, further comprising: transmitting, to the network entity, a request for Msg3 repetitions based at least in part on the mode of operation when downlink transmissions are associated with a first component carrier and uplink transmissions are associated with a second component carrier based at least in part on the mode of operation.

Aspect 12: The method of Aspect 11, wherein transmitting the request for Msg3 repetitions is based at least in part on a transmit power for a message 1 of the RACH procedure satisfying a threshold.

Aspect 13: The method of Aspect 11, wherein transmitting the request for Msg3 repetitions is based at least in part on a message 1 of the RACH procedure being transmitted to the network entity with repetitions.

Aspect 14: The method of Aspect 11, wherein transmitting the request for Msg3 repetitions is based at least in part on a synchronization signal block reference signal received power measurement not satisfying a threshold level.

Aspect 15: The method of any of Aspects 1 through 14, wherein the repetitions are network entity initiated Msg3 repetitions based at least in part on the mode of operation.

Aspect 16: The method of Aspect 15, wherein transmitting the Msg3 with repetitions comprises transmitting the Msg3 with repetitions without transmitting a request for Msg3 repetitions to the network entity when the repetitions are network entity initiated Msg3 repetitions based at least in part on the mode of operation.

Aspect 17: The method of Aspect 15, further comprising: transmitting, to the network entity, a first indication that indicates one or more of a transmit power of a message 1 (Msg1) during the RACH procedure or a power headroom indicating additional power available in relation to the transmit power of the Msg1, when the repetitions are network entity initiated Msg3 repetitions based at least in part on the mode of operation; and receiving, from the network entity, a second indication that indicates a granted quantity of Msg3 repetitions based at least in part on the first indication.

Aspect 18: The method of Aspect 17, wherein transmitting the first indication comprises transmitting the first indication based at least in part on an uplink control information multiplexing on a Msg3 physical uplink shared channel.

Aspect 19: The method of Aspect 17, wherein transmitting the first indication comprises transmitting the first indication using Msg3 physical uplink shared channel demodulation reference signal resources.

Aspect 20: A method of wireless communication performed by a network entity, comprising: receiving, from a user equipment (UE), a message 3 (Msg3) with repetitions during a random access channel (RACH) procedure based at least in part on one or more of a mode of operation or an uplink-downlink channel reciprocity; and transmitting, to the UE, a connection setup message for establishing a connection between the network entity and the UE based at least in part on a successful decoding of the Msg3.

Aspect 21: The method of Aspect 20, wherein the mode of operation is a time division duplexing mode that utilizes an unpaired spectrum, and wherein downlink transmissions and uplink transmissions are associated with a single component carrier.

Aspect 22: The method of any of Aspects 20 through 21, wherein the mode of operation is a time division duplexing mode that utilizes an unpaired spectrum, and wherein downlink transmissions are associated with a first component carrier and uplink transmissions are associated with a second component carrier.

Aspect 23: The method of any of Aspects 20 through 22, wherein the mode of operation is a frequency division duplexing mode that utilizes a paired spectrum, and wherein downlink transmissions are associated with a downlink component carrier and uplink transmissions are associated with an uplink component carrier.

Aspect 24: The method of any of Aspects 20 through 23, wherein the repetitions are UE-initiated Msg3 repetitions based at least in part on the mode of operation, wherein the mode of operation is a time division duplexing mode in which downlink transmissions and uplink transmissions are associated with a single component carrier or separate component carriers, or the mode of operation is a frequency division duplexing mode in which downlink transmissions and uplink transmissions are associated with separate component carriers.

Aspect 25: The method of Aspect 24, further comprising: receiving, from the UE, a request for Msg3 repetitions when the repetitions are UE-initiated Msg3 repetitions based at least in part on the mode of operation; and transmitting, to the UE, an indication that indicates a granted quantity of Msg3 repetitions based at least in part on the request.

Aspect 26: The method of Aspect 25, wherein receiving the request for Msg3 repetitions comprises receiving the request in a message 1 of the RACH procedure.

Aspect 27: The method of Aspect 25, wherein receiving the request for Msg3 repetitions comprises receiving the request in the Msg3 of the RACH procedure.

Aspect 28: The method of any of Aspects 20 through 27, wherein receiving the Msg3 with repetitions comprises receiving the Msg3 with repetitions based at least in part on an uplink channel condition, wherein the uplink channel condition is determined from a downlink channel condition based at least in part on the uplink-downlink channel reciprocity, and wherein downlink transmissions are associated with a first component carrier and uplink transmissions are associated with a second component carrier based at least in part on the mode of operation.

Aspect 29: The method of any of Aspects 20 through 28, further comprising: transmitting, to the UE, a RACH occasion configuration or a synchronization signal block to RACH occasion mapping configuration that configures the UE for UE-initiated Msg3 repetitions.

Aspect 30: The method of any of Aspects 20 through 29, further comprising: receiving, from the UE, a request for Msg3 repetitions based at least in part on the mode of operation when downlink transmissions are associated with a first component carrier and uplink transmissions are associated with a second component carrier based at least in part on the mode of operation.

Aspect 31: The method of Aspect 30, wherein receiving the request for Msg3 repetitions is based at least in part on a transmit power for a message 1 of the RACH procedure satisfying a threshold.

Aspect 32: The method of Aspect 30, wherein receiving the request for Msg3 repetitions is based at least in part on a message 1 of the RACH procedure being received from the UE with repetitions.

Aspect 33: The method of Aspect 30, wherein receiving the request for Msg3 repetitions is based at least in part on a synchronization signal block reference signal received power measurement not satisfying a threshold level.

Aspect 34: The method of any of Aspects 20 through 33, wherein the repetitions are network entity initiated Msg3 repetitions based at least in part on the mode of operation.

Aspect 35: The method of Aspect 34, wherein receiving the Msg3 with repetitions comprises receiving the Msg3 with repetitions without receiving a request for Msg3 repetitions from the UE when the repetitions are network entity initiated Msg3 repetitions based at least in part on the mode of operation.

Aspect 36: The method of Aspect 34, further comprising: receiving, from the UE, a first indication that indicates one or more of a transmit power of a message 1 (Msg1) during the RACH procedure or a power headroom indicating additional power available in relation to the transmit power of the Msg1, when the repetitions are network entity initiated Msg3 repetitions based at least in part on the mode of operation; and transmitting, to the UE, a second indication that indicates a granted quantity of Msg3 repetitions based at least in part on the first indication.

Aspect 37: The method of Aspect 36, wherein receiving the first indication comprises receiving the first indication based at least in part on an uplink control information multiplexing on a Msg3 physical uplink shared channel.

Aspect 38: The method of Aspect 36, wherein receiving the first indication comprises receiving the first indication using Msg3 physical uplink shared channel demodulation reference signal resources.

Aspect 39: An apparatus for wireless communication at a device, comprising a processor; memory coupled with the processor; and instructions stored in the memory and executable by the processor to cause the apparatus to perform the method of one or more of Aspects 1-19.

Aspect 40: A device for wireless communication, comprising a memory and one or more processors coupled to the memory, the one or more processors configured to perform the method of one or more of Aspects 1-19.

Aspect 41: An apparatus for wireless communication, comprising at least one means for performing the method of one or more of Aspects 1-19.

Aspect 42: A non-transitory computer-readable medium storing code for wireless communication, the code comprising instructions executable by a processor to perform the method of one or more of Aspects 1-19.

Aspect 43: A non-transitory computer-readable medium storing a set of instructions for wireless communication, the set of instructions comprising one or more instructions that, when executed by one or more processors of a device, cause the device to perform the method of one or more of Aspects 1-19.

Aspect 44: An apparatus for wireless communication at a device, comprising a processor; memory coupled with the processor; and instructions stored in the memory and executable by the processor to cause the apparatus to perform the method of one or more of Aspects 20-38.

Aspect 45: A device for wireless communication, comprising a memory and one or more processors coupled to the memory, the one or more processors configured to perform the method of one or more of Aspects 20-38.

Aspect 46: An apparatus for wireless communication, comprising at least one means for performing the method of one or more of Aspects 20-38.

Aspect 47: A non-transitory computer-readable medium storing code for wireless communication, the code comprising instructions executable by a processor to perform the method of one or more of Aspects 20-38.

Aspect 48: A non-transitory computer-readable medium storing a set of instructions for wireless communication, the set of instructions comprising one or more instructions that, when executed by one or more processors of a device, cause the device to perform the method of one or more of Aspects 20-38.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
determining one or more of a mode of operation or an uplink-downlink channel reciprocity; and
transmitting, to a network entity, a message 3 (Msg3) with repetitions during a random access channel (RACH) procedure based at least in part on one or more of the mode of operation or the uplink-downlink channel reciprocity.

2. The method of claim 1, wherein the mode of operation is a time division duplexing mode that utilizes an unpaired spectrum, and wherein downlink transmissions and uplink transmissions are associated with a single component carrier.

3. The method of claim 1, wherein the mode of operation is a time division duplexing mode that utilizes an unpaired spectrum, and wherein downlink transmissions are associated with a first component carrier and uplink transmissions are associated with a second component carrier.

4. The method of claim 1, wherein the mode of operation is a frequency division duplexing mode that utilizes a paired spectrum, and wherein downlink transmissions are associated with a downlink component carrier and uplink transmissions are associated with an uplink component carrier.

5. The method of claim 1, wherein the repetitions are UE-initiated Msg3 repetitions based at least in part on the mode of operation, wherein the mode of operation is a time division duplexing mode in which downlink transmissions and uplink transmissions are associated with a single component carrier or separate component carriers, or the mode of operation is a frequency division duplexing mode in which downlink transmissions and uplink transmissions are associated with separate component carriers.

6. The method of claim 5, further comprising:
transmitting, to the network entity and in a message 1 of the RACH procedure or in the Msg3 of the RACH procedure, a request for Msg3 repetitions when the repetitions are UE-initiated Msg3 repetitions based at least in part on the mode of operation; and
receiving, from the network entity, an indication that indicates a granted quantity of Msg3 repetitions based at least in part on the request.

7. The method of claim 1, further comprising:
determining an uplink channel condition from a downlink channel condition based at least in part on the uplink-downlink channel reciprocity, wherein downlink transmissions are associated with a first component carrier and uplink transmissions are associated with a second component carrier based at least in part on the mode of operation, and wherein transmitting the Msg3 with repetitions is based at least in part on the uplink channel condition.

8. The method of claim 1, further comprising:
receiving, from the network entity, a RACH occasion configuration or a synchronization signal block to RACH occasion mapping configuration that configures the UE for UE-initiated Msg3 repetitions.

9. The method of claim 1, further comprising:
transmitting, to the network entity, a request for Msg3 repetitions based at least in part on the mode of operation when downlink transmissions are associated with a first component carrier and uplink transmissions are associated with a second component carrier based at least in part on the mode of operation.

10. The method of claim 9, wherein:
transmitting the request for Msg3 repetitions is based at least in part on a transmit power for a message 1 of the RACH procedure satisfying a threshold;
transmitting the request for Msg3 repetitions is based at least in part on the message 1 of the RACH procedure being transmitted to the network entity with repetitions; or
transmitting the request for Msg3 repetitions is based at least in part on a synchronization signal block reference signal received power measurement not satisfying a threshold level.

11. The method of claim 1, wherein the repetitions are network entity initiated Msg3 repetitions based at least in part on the mode of operation.

12. The method of claim 11, wherein transmitting the Msg3 with repetitions comprises transmitting the Msg3 with repetitions without transmitting a request for Msg3 repetitions to the network entity when the repetitions are network entity initiated Msg3 repetitions based at least in part on the mode of operation.

13. The method of claim 11, further comprising:
transmitting, to the network entity, a first indication that indicates one or more of a transmit power of a message 1 (Msg1) during the RACH procedure or a power headroom indicating additional power available in relation to the transmit power of the Msg1, when the repetitions are network entity initiated Msg3 repetitions based at least in part on the mode of operation; and
receiving, from the network entity, a second indication that indicates a granted quantity of Msg3 repetitions based at least in part on the first indication.

14. The method of claim 13, wherein transmitting the first indication comprises:
transmitting the first indication based at least in part on an uplink control information multiplexing on a Msg3 physical uplink shared channel; or
transmitting the first indication using Msg3 physical uplink shared channel demodulation reference signal resources.

15. A method of wireless communication performed by a network entity, comprising:
receiving, from a user equipment (UE), a message 3 (Msg3) with repetitions during a random access channel (RACH) procedure based at least in part on one or more of a mode of operation or an uplink-downlink channel reciprocity; and
transmitting, to the UE, a connection setup message for establishing a connection between the network entity and the UE based at least in part on a successful decoding of the Msg3.

16. A user equipment (UE) for wireless communication, comprising:
a memory; and
one or more processors, coupled to the memory, configured to:
determine one or more of a mode of operation or an uplink-downlink channel reciprocity; and
transmit, to a network entity, a message 3 (Msg3) with repetitions during a random access channel (RACH) procedure based at least in part on one or more of the mode of operation or the uplink-downlink channel reciprocity.

17. The UE of claim 16, wherein the mode of operation is a time division duplexing mode that utilizes an unpaired spectrum, and wherein downlink transmissions and uplink transmissions are associated with a single component carrier.

18. The UE of claim 16, wherein the mode of operation is a time division duplexing mode that utilizes an unpaired spectrum, and wherein downlink transmissions are associated with a first component carrier and uplink transmissions are associated with a second component carrier.

19. The UE of claim 16, wherein the mode of operation is a frequency division duplexing mode that utilizes a paired spectrum, and wherein downlink transmissions are associated with a downlink component carrier and uplink transmissions are associated with an uplink component carrier.

20. The UE of claim 16, wherein the repetitions are UE-initiated Msg3 repetitions based at least in part on the mode of operation, wherein the mode of operation is a time division duplexing mode in which downlink transmissions and uplink transmissions are associated with a single component carrier or separate component carriers, or the mode of operation is a frequency division duplexing mode in which downlink transmissions and uplink transmissions are associated with separate component carriers.

21. The UE of claim 20, wherein the one or more processors are further configured to:
transmit, to the network entity and in a message 1 of the RACH procedure or in the Msg3 of the RACH procedure, a request for Msg3 repetitions when the repetitions are UE-initiated Msg3 repetitions based at least in part on the mode of operation; and
receive, from the network entity, an indication that indicates a granted quantity of Msg3 repetitions based at least in part on the request.

22. The UE of claim 16, wherein the one or more processors are further configured to:
determine an uplink channel condition from a downlink channel condition based at least in part on the uplink-downlink channel reciprocity, wherein downlink transmissions are associated with a first component carrier and uplink transmissions are associated with a second component carrier based at least in part on the mode of operation, and wherein transmitting the Msg3 with repetitions is based at least in part on the uplink channel condition.

23. The UE of claim 16, wherein the one or more processors are further configured to:
receive, from the network entity, a RACH occasion configuration or a synchronization signal block to RACH occasion mapping configuration that configures the UE for UE-initiated Msg3 repetitions.

24. The UE of claim 16, wherein the one or more processors are further configured to:
transmit, to the network entity, a request for Msg3 repetitions based at least in part on the mode of operation when downlink transmissions are associated with a first component carrier and uplink transmissions are associated with a second component carrier based at least in part on the mode of operation.

25. The UE of claim 24, wherein the one or more processors, to transmit the request for Msg3 repetitions, are configured to:
transmit the request based at least in part on a transmit power for a message 1 of the RACH procedure satisfying a threshold;
transmit the request based at least in part on the message 1 of the RACH procedure being transmitted to the network entity with repetitions; or
transmit the request based at least in part on a synchronization signal block reference signal received power measurement not satisfying a threshold level.

26. The UE of claim 16, wherein the repetitions are network entity initiated Msg3 repetitions based at least in part on the mode of operation.

27. The UE of claim 26, wherein the one or more processors, to transmit the Msg3 with repetitions, are configured to transmit the Msg3 with repetitions without transmitting a request for Msg3 repetitions to the network entity when the repetitions are network entity initiated Msg3 repetitions based at least in part on the mode of operation.

28. The UE of claim 26, wherein the one or more processors are further configured to:
transmit, to the network entity, a first indication that indicates one or more of a transmit power of a message 1 (Msg1) during the RACH procedure or a power headroom indicating additional power available in relation to the transmit power of the Msg1, when the repetitions are network entity initiated Msg3 repetitions based at least in part on the mode of operation; and
receive, from the network entity, a second indication that indicates a granted quantity of Msg3 repetitions based at least in part on the first indication.

29. The UE of claim 28, wherein the one or more processors, to transmit the first indication, are configured to:
transmit the first indication based at least in part on an uplink control information multiplexing on a Msg3 physical uplink shared channel; or
transmit the first indication using Msg3 physical uplink shared channel demodulation reference signal resources.

30. A network entity for wireless communication, comprising:
a memory; and
one or more processors, coupled to the memory, configured to:
receive, from a user equipment (UE), a message 3 (Msg3) with repetitions during a random access channel (RACH) procedure based at least in part on one or more of a mode of operation or an uplink-downlink channel reciprocity; and
transmit, to the UE, a connection setup message for establishing a connection between the network entity and the UE based at least in part on a successful decoding of the Msg3.
